(19) United States
(12) Patent Application Publication
(10) Pub. No.: US 2024/0197451 A1
(43) Pub. Date: Jun. 20, 2024

(54) DEVICE FOR SCREWING IN DENTAL IMPLANTS

(71) Applicant: SCREWEASY S.L., ALICANTE (ES)

(72) Inventor: Gustavo Cesar Rubio Facelli, Alicante (ES)

(21) Appl. No.: 18/287,214

(22) PCT Filed: May 31, 2022
(86) PCT No.: PCT/ES2022/070333

§ 371 Date: Oct. 17, 2023

(30) Foreign Application Priority Data
Jun. 7, 2021 (ES) U202131170

(51) Int. Cl. A61C 13/225; A61C 1/04; A61C 1/12; A61C 1/14

(52) U.S. Cl. CPC A61C 13/225; A61C 1/04; A61C 1/12; A61C 1/141; A61C 1/145

(57) ABSTRACT

The present invention relates to a device (1) for screwing dental implants (101) which includes: a screw-in tip (2) comprising a machined actuator (20), suitably shaped to drive the attachment screw (100) for attaching the dental implant (101); a handle (3) comprising an end head (30) in which the screw-in tip (2) is mounted and having an actuation control (31) for actuating the rotation of the screw-in tip (2) in an area opposite to said head (30); and a transmission (32) arranged inside said handle (3) connecting the actuation control (31) to the screw-in tip (2).

### SUBJECT OF THE INVENTION

The present invention involves a device for screwing in dental implants and is meant to be used by dental professionals.

### PREDECESSORS OF THE INVENTION

At present, in order to screw dental implants into their anchors, affixed into the bone under the gums, screwdrivers are used, which are comprised of a straight shaft with a mechanical actuator on the screw at one end and a small knob at the opposite end. This length of the shaft is small in order to fit in the oral cavity during the operation, and the knob is wide enough to be used with the dentist's two fingers, at 5-10 millimetres in diameter.

This configuration has several drawbacks. Mainly, it is difficult to work, due to the minimal space available inside the oral cavity. As a consequence of the above, the screwdriver—or the screw itself—can often fall into the mouth, or even be swallowed by the patient.

### DESCRIPTION OF THE INVENTION

The device for screwing in the invention of dental implants is comprised of, in its most generic form:
a screwdriver bit, comprised of a machined actuator with a shape suitable for driving in the dental implant fixing screw (a blade or a prismatic protrusion, for example),
a handle, comprised of an end head where the screwdriver bit is mounted, while opposite to said head there is an actuating controller for rotating the screwdriver bit, and
a transmission located on the inside of said handle, which connects the actuating controller with the screwdriver bit, directly or indirectly—that is, through a bit holder where the screwdriver bit is mounted, but detachable.

In this way, the handle can be made large enough so that the dentist's hand does not have to work inside the patient's mouth at any time during the operation, improving the grip from the outside of the mouth and, ideally, placing the controller outside of the oral cavity, which increases the comfort both of the practitioner and the patient during the procedure and increases safety, since it is impossible for the screwdriver to fall into the oral cavity due to its dimensions and the fact that it is held outside the mouth.

In addition, the bit can be detachable and the device can be used with bits of any specifications.

### BRIEF DESCRIPTION OF THE DRAWINGS

FIG. 1.—Shows a view of a dental contra angle, from which the invented device was derived.

FIG. 2.—Shows a general view of the invented device.

FIG. 3.—Shows a view of how to use the invented device.

FIG. 4.—Shows an enlarged view of the head of the invented device, configured using the dental contra angle bit holder.

FIG. 5.—Shows a view of how to use the invented device on a dental mould, to see it in use more clearly.

FIG. 6.—Shows a detail of the mechanical engagement of the knob, of the invented device, which is configured by the dental contra angle's actuating controller.

### DESCRIPTION OF THE PREFERRED FORM OF IMPLEMENTATION

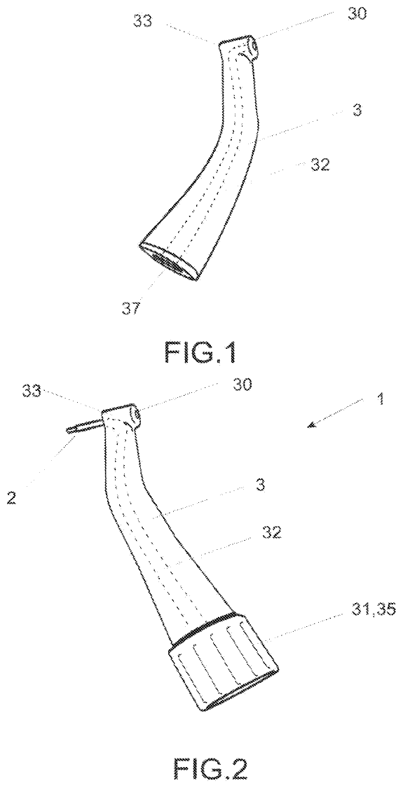

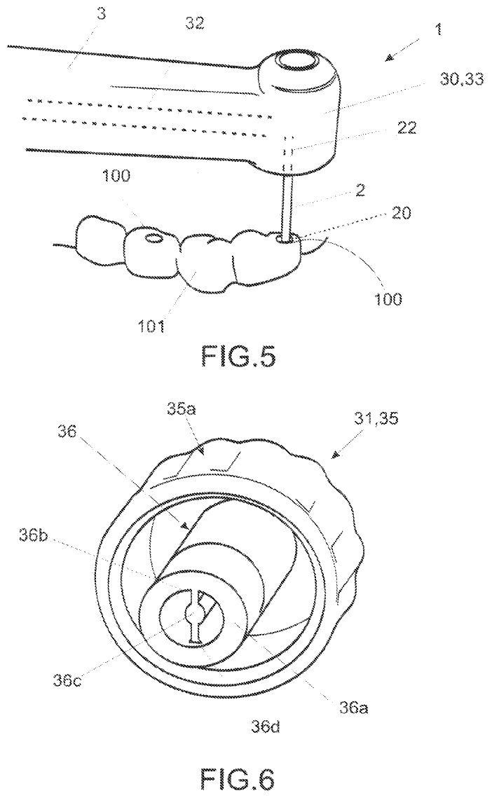

The invented device (1) for screwing in dental implants (101) is comprised of (see FIGS. 2 and 4):
a screwdriver bit (2) comprised of a mechanical actuator (20), suitably shaped to drive in the screw (100) for fastening the dental implant (101) (see also FIG. 5),
a handle (3), comprised of a head (30) on one end where the screwdriver bit (2) is mounted, while opposite to said head (30) there is an actuating controller (31) for rotating the screwdriver bit (2), and
a transmission (32) located on the inside of said handle (3), which is connects the actuating controller (31) with the screwdriver bit (2).

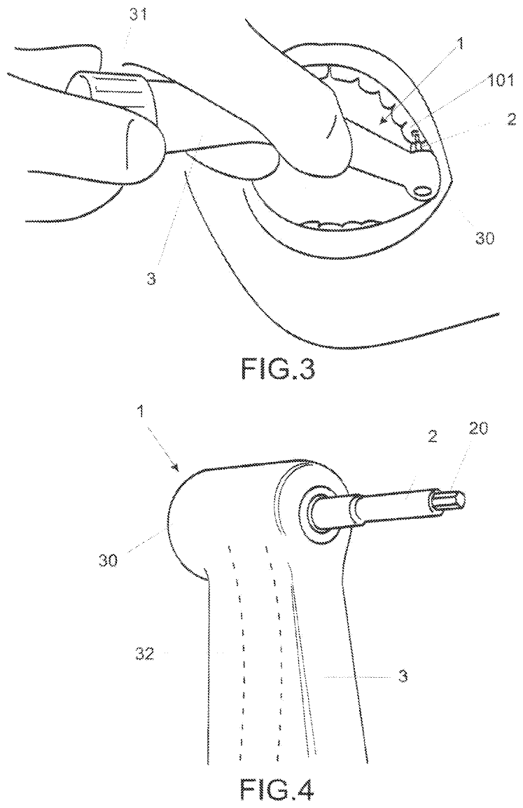

Preferably, the handle (3) is big enough for the actuating controller (31) to be on the outside of the oral cavity; for example, a length between 5 and 10 centimetres (see FIG. 3).

Very preferably, the handle (3) is comprised of a dental contra angle (see FIG. 1)—which is a tool widely used by dentists, and which, on the one hand, is commercially available, exists, and allows the invention to be easily implemented; and on the other hand, already incorporates the transmission (32) inside it—is comprised of the screwdriver bit (2) (see FIG. 5), a proximal end (22), opposite to the mechanical actuator (20), which is detachable and connected to the bit holder (33) of said dental contra angle—with the bit holder (33) configuring the head (30) of the handle (3)—, and with the actuating controller (31) comprised of a knob (35) or crank (see FIGS. 2 and 3) provided with mechanical coupling (36) (see FIG. 6) to the end of the inner shaft (37) (see FIG. 1) of the transmission (32) of said contra angle. Thus, implementing the invention is as easy as manufacturing the knob (35) or crank and attaching it to the contra angle on the instrument tray of the dentist's chair.

In the representation shown in the figures, the mechanical coupling (36) is comprised of (see FIG. 6) a cylindrical tubular protrusion (36a), inside of which there is a partition (36b) centred diametrically with a central recess (36c), and clipping notches (36d) adapted to the end of the inner shaft (37) of the contra angle's transmission (32), which, logically, will vary on a case-by-case basis and adapt to the specific shape of said end. Furthermore, in this case, the knob (35) is comprised of a ribbing (35a) or roulette to make it easier to operate.

Notwithstanding the foregoing, and since the description given corresponds only to an example of preferred embodiment of the invention, it shall be understood that, with the same basic idea, multiple variations of detail may be introduced, and likewise protected, which may affect the shape, size, or manufacturing materials for the assembly or its parts, without this involving any alteration of the invention as a whole, delimited only by the claims provided in the following.

1. Device (1) for screwing in dental implants (101); characterised in that it is comprised of:
a screwdriver bit (2) comprised of a mechanical actuator (20), suitably shaped to drive in the fastening screw (100) for the dental implant (101),
a handle (3), comprised of a head (30) on one end where the screwdriver bit (2) is mounted, while opposite to said head (30) there is an actuating controller (31) for rotating the screwdriver bit (2), and
a transmission (32) located on the inside of said handle (3), which is connects the actuating controller (31) with the screwdriver bit (2).

2. Device (1) for screwing in dental implants (101) according to claim 1, wherein the handle (3) is big enough for the actuating controller (31) to be on the outside of the oral cavity.

3. Device (1) for screwing in dental implants (101) according to claim 2, wherein the handle (3) has a length between 5 and 10 centimetres.

4. Device (1) for screwing in dental implants (101) according to claim 1, wherein there is a handle (3) comprised of a dental contra angle; a screwdriver bit (2) comprised of a proximal end (22) opposite the mechanical actuator (20), which is detachable and coupled with the bit holder (33) of said dental contra angle; and, comprising the actuating controller (31), a knob (35) or crank provided with a mechanical coupling (36) to the end of the inner shaft (37) of the transmission (32) of said counter-angle.

5. Device (1) for screwing in dental implants (101) according to claim 4, wherein the mechanical coupling (36) is comprised of a tubular cylindrical projection (36a), inside of which there is a partition (36b) centred diametrically, thicker in the middle, (36c) and clipping notches (36d) adapted to the end of the inner shaft (37) of the contra angle's transmission (32).

6. Device (1) for screwing in dental implants (101) according to claim 5, wherein the knob (35) employs a ribbing (35a) or routing.
